(19) United States
(12) Patent Application Publication
(10) Pub. No.: US 2008/0089190 A1
(43) Pub. Date: Apr. 17, 2008

(54) AUTOMATED DATA STORAGE LIBRARY ROBOT ACCESSORS WITH PIVOTING GRIPPERS FOR PASSING

(76) Inventors: Andrew Stuart Green, Tucson, AZ (US); Thomas William Haberman, Tucson, AZ (US); Shawn Michael Nave, Tucson, AZ (US)

Correspondence Address: JOHN H. HOLCOMBE;IBM CORPORATION, IP LAW DEPT., 8987 E. TANQUE VERDE RD., #309-374, TUCSON, AZ, 85749, US

(21) Appl. No.: 11/549,794

(22) Filed: Oct. 16, 2006

(51) Int. Cl. G11B 21/08

(52) U.S. Cl. 369/30.38

(57) ABSTRACT

An automated data storage library, employing storage shelves and data storage drives arranged to “X” and “Y” directions on both sides of an “X” axis, has a plurality of robot accessors configured to move in the “X” direction along one or more “X” rail(s) in separate paths. The robot accessors each have gripper apparatus movable in the “Y” direction and configured to access the storage shelves and the data storage drive(s) in the “Z” direction. The gripper apparatus is configured to pivot about an axis of the robot accessor away from the “Z” direction to provide clearance of the gripper apparatus in the “Z” direction with respect to another robot accessor such that the at least two robot accessors may pass each other in the “X” direction. The gripper may pivot between the “Z” direction and substantially the “Y” direction, or between the “Z” direction and substantially the “X” direction.

### FIELD OF THE INVENTION

This invention relates to automated data storage libraries, and, more particularly, to automated data storage libraries with multiple robot accessors.

### BACKGROUND OF THE INVENTION

Automated data storage libraries provide a capability for storage of large amounts of data, for example, in data storage cartridges stored in storage shelves contained in one or more cabinets or frames. The data storage cartridges may comprise magnetic tape or disks, optical disks, or electronic media. The cartridges are stored in the storage shelves until a particular media is needed and are accessible by means of a robot accessor. The robot accessor accesses and moves one or more data storage cartridges between storage shelves and data storage drives, where data may be read from the data storage cartridges or new data written.

In one example, the automated data storage library has a rail in the “X”, or horizontal direction for mounting the robot accessor for movement back and forth in the “X” direction, and has storage shelves and data storage drives arranged in the “X” and “Y”, or vertical, directions on at least one side of the rail. The storage shelves and/or data storage drives are typically provided on both sides of the rail, forming an aisle. The robot accessor has gripper apparatus that is positioned on the accessor so as to be centrally located from either side of the aisle and is configured to access the storage shelves and/or data storage drives on both sides of the aisle.

Dual robot accessors have been provided to speed the access to the data storage cartridges, and typically are mounted on the same rail and travel in the “X” direction along the same path. In one example, each of the robot accessors is assigned to a fixed or variable zone of the library, in the “X” direction, to make sure that the robot accessors do not collide. Thus, the typical dual robot accessor does not have access to the entire library. In another example, one of the robot accessors is moved into a garage area, such that the one remaining robot accessor has access to the entire library. Thus, only one robot accessor has access to the library at a time.

### SUMMARY OF THE INVENTION

Automated data storage libraries, robot accessors, and methods are configured to allow multiple robot accessors to pass each other in the “X” direction.

In one embodiment, an automated data storage library comprises a plurality of storage shelves arranged in the “X” and “Y” directions on at least one side of an “X” axis, and displaced in the “Z” direction from the “X” axis. Data storage drive(s) are arranged on at least one side of the “X” axis, displaced in the “Z” direction from the “X” axis. At least one “X” rail extends parallel to the “X” axis, and a plurality of robot accessors are configured to move in the “X” direction along the “X” rail(s), at least two of the robot accessors configured to move in separate paths parallel to the “X” axis. The robot accessors each have gripper apparatus, the gripper apparatus configured to access items with respect to the storage shelves and the data storage drive(s) by operating in the “Z” direction. The robot accessor is configured to move the gripper apparatus in the “Y” direction. In addition, at least one of the gripper apparatus is configured to pivot about an axis of the robot accessor away from substantially the “Z” direction to provide clearance of the gripper apparatus in the “Z” direction with respect to another robot accessor on a separate path such that the two robot accessors may pass each other in the “X” direction.

In a further embodiment, the gripper apparatus of both of the two robot accessors are configured to pivot about the axis of the associated robot accessor away from substantially the “Z” direction to provide clearance with respect to another robot accessor in the “Z” direction.

In another embodiment, the gripper apparatus is configured to pivot about the axis between substantially the “Z” direction and substantially the “Y” direction.

In still another embodiment, the gripper apparatus is configured to pivot about the axis between substantially the “Z” direction and substantially the “X” direction.

For a further understanding of the present invention, reference should be made to the following detailed description taken in conjunction with the accompanying drawings.

### BRIEF DESCRIPTION OF THE DRAWINGS

FIG. 1 is an illustration of an automated data storage library in accordance with the present invention;

FIG. 2 is a diagrammatic illustration of the automated data storage library of FIG. 1 with the gripper apparatus in substantially the “Z” direction;

FIG. 3 is a diagrammatic illustration of the automated data storage library of FIGS. 1 and 3 with the gripper apparatus in substantially the “Y” direction;

FIG. 4 is a diagrammatic illustration of an alternative embodiment of the automated data storage library of FIGS. 1 and 2 with the gripper apparatus in substantially the “Y” direction;

FIG. 5 is a diagrammatic illustration of an alternative embodiment of the automated data storage library of FIG. 1 with a single “X” rail, and with the gripper apparatus in substantially the “Z” direction;

FIG. 6 is a diagrammatic illustration of the automated data storage library of FIG. 5 with the gripper apparatus in substantially the “Y” direction;

FIG. 7 is a top diagrammatic illustration of an alternative embodiment of the automated data storage library of FIG. 5 with the gripper apparatus in substantially the “Z” direction.

FIG. 8 is a top diagrammatic illustration of the automated data storage library of FIG. 7 with the gripper apparatus in substantially the “X” direction; and

FIG. 9 is a top diagrammatic illustration of an automated data storage library with three robot accessors.

### DETAILED DESCRIPTION OF THE INVENTION

The invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

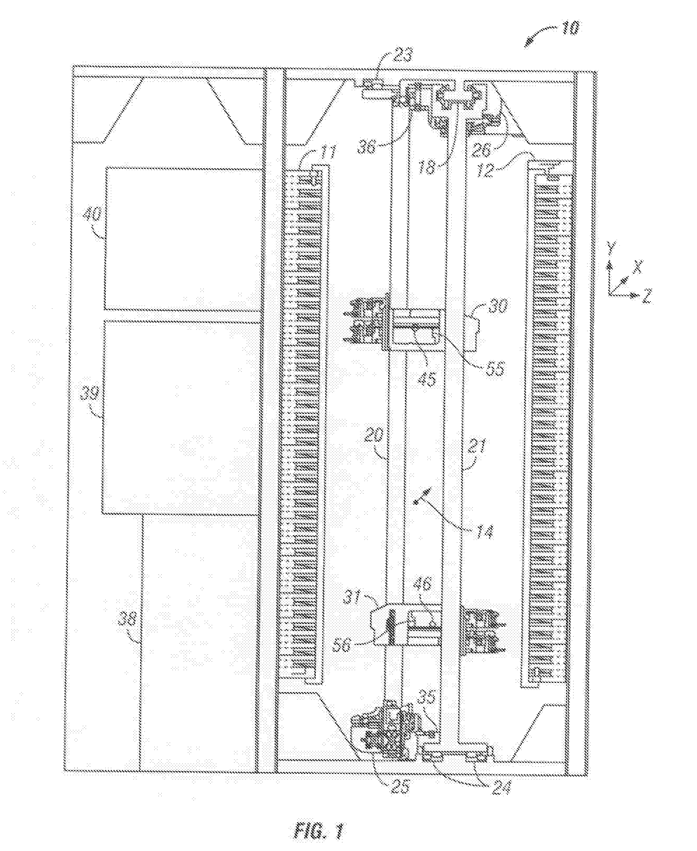

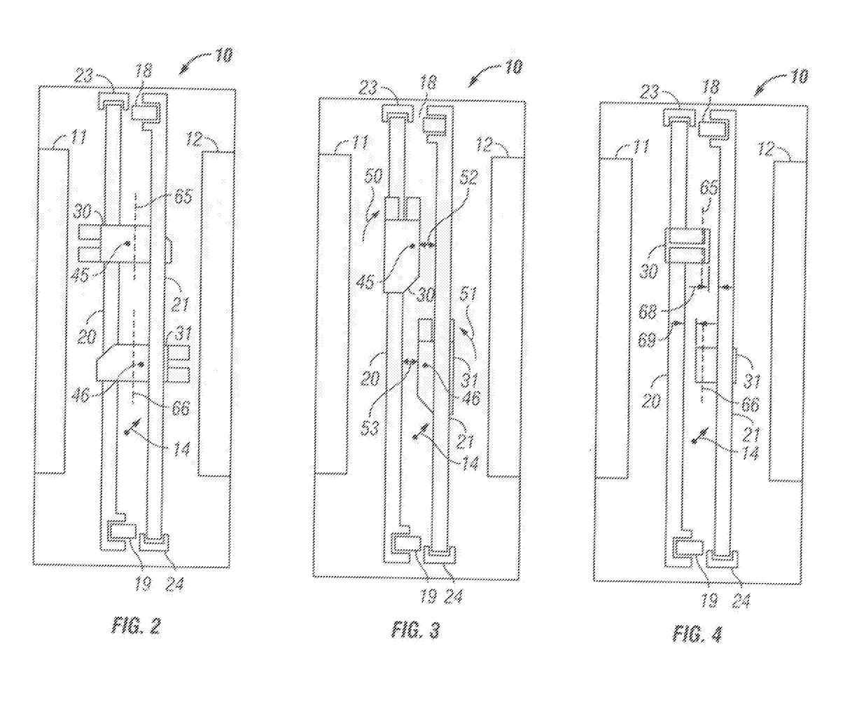

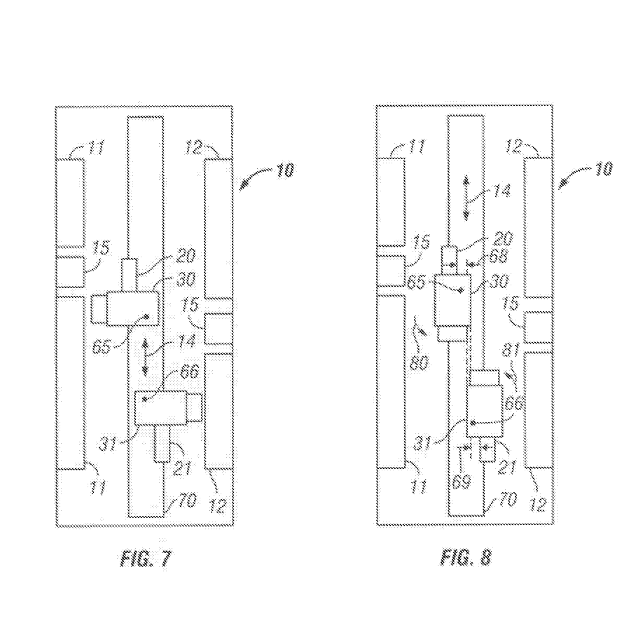

Referring to FIGS. 1 and 2, in one embodiment, an automated data storage library 10 comprises a plurality of storage shelves 11, 12 arranged in the “X”, or horizontal, and “Y”, or vertical, directions on either side of an “X” axis 14, and displaced in the “Z” direction, substantially perpendicular to the “X” and “Y” directions, from the “X” axis. Herein, the exemplary directions may be altered to any substantially mutually perpendicular directions. Data storage drives (15 in FIGS. 7 and 8) are arranged on either side of the “X” axis, displaced in the “Z” direction from the “X” axis.

Two “X” rails 18, 19 extend parallel to the “X” axis, supporting two robot accessors 20, 21. In the example, guideways 23, 24 guide and support the ends of the robot accessors 20, 21 opposite the “X” rails. The robot accessors 20, 21 are configured to move in the “X” direction along the “X” rails 18, 19, by motors 25, 26, for example, by fixed motors driving belts, chains, rack and pinion, or lead screws, attached to the robot accessors.

The two robot accessors 20, 21 thus move in separate paths along, and as represented by, the “X” rails 18, 19 parallel to the “X” axis 14.

The robot accessors 20, 21 each have gripper apparatus (or grippers) 30, 31 configured to access items, such as data storage cartridges, with respect to the storage devices 11, 12 and the data storage drive(s) by operating in the “Z” direction, as is known to those of skill in the art. The robot accessor is configured to move the gripper apparatus in the “Y” direction, for example, by motors 35, 36 on the robot accessors. Examples of drive mechanisms are lead screws, rack and pinion and drive belts or chains attached to the gripper apparatus.

The storage shelves 11, 12 and/or the data storage drives may be positioned on both sides of the “X” rails, forming an aisle. The gripper apparatus 30, 31 may be positioned on the accessor so as to be centrally located from either side of the aisle and be able to access the storage shelves and/or data storage drives on both sides of the aisle. The gripper apparatus may be configured to rotate horizontally 180 degrees to access both sides of the aisle, for example, to access a cartridge on one side of the aisle and deliver the cartridge to the other side of the aisle.

The central location of the gripper apparatus hinders passage of the robot accessors.

The gripper apparatus for each of the robot accessors is moved in the “X” direction by the “X” motion of the robot accessor, and in the “Y” direction by the “Y” motion of the gripper apparatus, and can be positioned by the “X” and “Y” movement at any of the storage shelves 11, 12, or the data storage drives 15.

The automated data storage library further comprises power supplies 38, and various electronics, such as a library manager 39 and a library control 40. A library manager may manage the inventory of data storage cartridges of the library or of a plurality of virtual libraries using the physical library 10, as is known to those of skill in the art, and a library control may control the functioning of the library in accordance with received commands, as is known to those of skill in the art.

An example of an automated data storage library that may be adapted in accordance with the present invention is the IBM® System Storage TS3500 Tape Library.

Referring additionally to FIG. 3, in accordance with the present invention, each of the gripper apparatus 30, 31 is configured to pivot about an axis 45, 46 of the robot accessor 20, 21 away from substantially the “Z” direction to substantially the “Y” direction, as shown by arrows 50, 51, to provide clearance 52, 53 of the gripper apparatus in the “Z” direction with respect to another robot accessor 21, 20 on a separate path such that the two robot accessors 20, 21 may pass each other in the “X” direction. Pivot motors 55, 56 are configured to pivot the respective gripper apparatus 30, 31 between substantially the “Z” direction and substantially the “Y” direction. In one example, each of the robot accessors can access both sides of the aisle by rotating horizontally 180 degrees.

By pivoting the gripper apparatus 30, 31 to the “Y” direction, the robot accessors 21, 20 are thus each able to be operated to move in the “X” direction and pass each other to move to any part of the automated data storage library 10, and are not limited to zones of the library. After having passed each other, the pivot motors 55, 56 pivot the respective gripper apparatus 30, 31 back to the “Z” direction.

In accordance with the present invention, a plurality of robot accessors 20 or 21 may be provided and may operate along one of the paths represented by the “X” rails 18, 19, for example, for increased availability. The robot accessors operating on the same one path will be unable to pass each other, but the robot accessor operating on a different path, if able to pivot its gripper apparatus in accordance with the present invention, will be able to pass any of the robot accessors on the one path that is able to pivot its gripper apparatus out of the way. For example, two robot accessors will be available on each path, so that the library would have four accessors available.

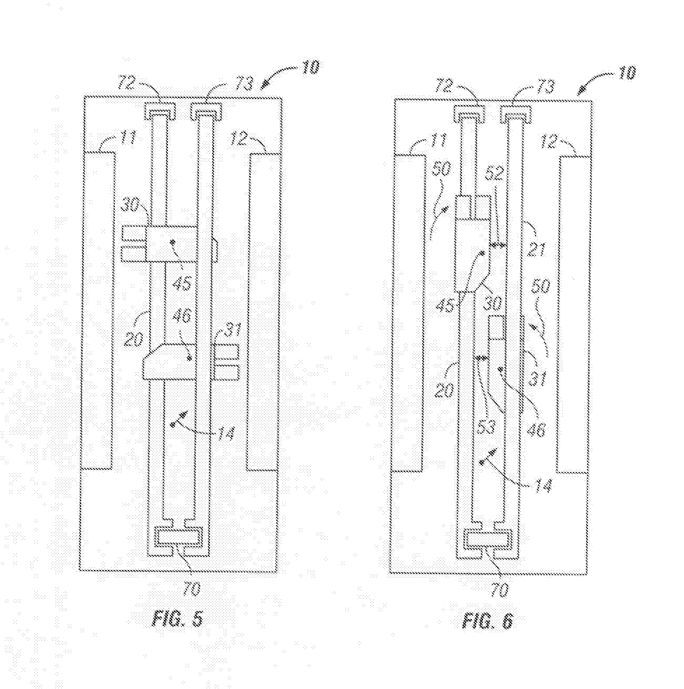

Referring to FIGS. 2 and 4, in accordance with another embodiment of the present invention, each to the gripper apparatus 30, 31 is configured to pivot about an axis 65, 66 which is substantially an axis in the “Y” direction of the robot accessor 20, 21 away from substantially the “Z” direction to substantially the “X” direction, to provide clearance 68, 69 of the gripper apparatus in the “Z” direction with respect to another robot accessor 21, 20 such that the two robot accessors 20, 21 thus move in separate paths along the “X” rails 18, 19 parallel to the “X” axis 14. After having passed each other, the gripper apparatus 30, 31 are each pivoted back to the “Z” direction.

The robot accessors 21, 20 are thus each able to be operated to move in the “X” direction to any part of the automated data storage library 10, and are not limited to zones of the library.

Referring to FIGS. 5 and 6, in another embodiment of the invention, the library 10 comprises a single “X” rail 70 and dual guideways 72, 73 which guide and support the ends of the robot accessors 20, 21 opposite the “X” rail 70. The robot accessors 20, 21 are configured to move in the “X” direction along the “X” rail 70, for example, by fixed motors driving belts, chains, rack and pinion, or lead screws, to drive the robot accessors.

The robot accessors 20, 21 thus move in separate paths along the “X” rail 70, the separate paths parallel to the “X” axis 14.

As discussed above, in accordance with the present invention, each of the gripper apparatus 30, 31 is configured to pivot about an axis 45, 46 of the robot accessor 20, 21 away from substantially the “Z” direction to substantially the “Y” direction, as shown by arrows 50, 51 to provide clearance 52, 53 of the gripper apparatus in the “Z” direction with respect to another robot accessor 21, 20 on a separate path. The robot accessors 21, 20 are thus each able to be operated to move in the “X” direction and pass each other to move to any part of the automated data storage library 10, and are not limited to zones of the library. After having passed each other, the gripper apparatus 30, 31 is pivoted back to the “Z” direction.

Referring to FIGS. 7 and 8, in another embodiment of the invention, shown from the top, the library 10 comprises a single “X” rail 70 and dual guideways (not shown) similar to guideways 72, 73 of FIGS. 5 and 6, which guide and support the ends of the robot accessors 20, 21 opposite the “X” rail 70. The robot accessors 20, 21 are configured to move in the “X” direction along the “X” rail 70, for example, by fixed motors driving belts or chains, rack and pinion, or lead screws, to drive the robot accessors.

Each of the gripper apparatus 30, 31 is configured to pivot about an axis 65, 66 which is substantially an axis in the “Y” direction of the robot accessor 20, 21 away from substantially the “Z” direction to substantially the “X” direction as shown by arrows 80 and 81, to provide clearance 68, 69 of the gripper apparatus in the “Z” direction with respect to another robot accessor 21, 20 on a separate path such that the two robot accessors 20, 21 may pass each other in the “X” direction. The robot accessors 20, 21 thus move in separate paths along the “X” rail 70 parallel to the “X” axis 14. After having passed each other, the gripper apparatus 30, 31 are each pivoted back to the “Z” direction.

The robot accessors 20, 21 are thus each able to be operated to move in the “X” direction to any part of the automated data storage library 10, and are not limited to zones of the library, but may access any of the storage shelves 11, 12 and any of the data storage drives 15, for example, by pivoting the gripper apparatus 30, 31 about the respective “Y” axis 65 or 66 to the original or to the opposite “Z” direction.

Further, referring to FIGS. 2, 5 and 7, the robot accessors 20, 21 may comprise pivot motors for pivoting the gripper apparatus both about the respective “X” axis 45, 46 and the respective “Y” axis 65, 66 to pivot the gripper apparatus about the “X” axis to provide the clearance to pass, and to pivot the gripper apparatus about the “Y” axis to go to either “Z” direction to access the storage shelves 11 or the storage shelves 12 on either side of the library 10.

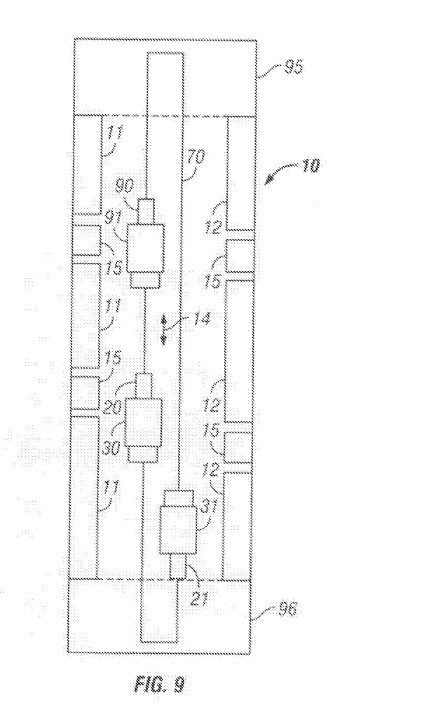

FIG. 9 illustrates an example of two robot accessors 20 and 90 on the same path. The robot accessors 20, 90 operating on the same path will be unable to pass each other, but when they pivot their gripper apparatus 30 and 91 away from the “Z” direction, for example, to the “X” direction, and robot accessor 21 pivots its gripper apparatus 31 out of the way, the robot accessors on different paths may pass one another. In the example, a single “X” rail 70 is illustrated extending in the “X” axis 14. Robot accessors 20 and 90 may thus operate in different fixed or variable zones, or one accessor may be moved into a garage area 95, 96 while the other accesses the entire library.

Those of skill in the art will understand that changes may be made with respect to the operations discussed above, including changes to the ordering of the steps. Further, those of skill in the art will understand that differing specific component arrangements may be employed than those illustrated herein.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. An automated data storage library comprising:
a plurality of storage shelves arranged in the “X” and “Y” directions on at least one side of an “X” axis, displaced in the “Z” direction from said “X” axis;
at least one data storage drive on at least one side of said “X” axis, displaced in said “Z” direction from said “X” axis;
at least one “X” rail extending parallel to said “X” axis; and
a plurality of robot accessors configured to move in said “X” direction along said at least one “X” rail, at least two of said robot accessors configured to move in separate paths parallel to said “X” axis; said robot accessors each having gripper apparatus, said robot accessor configured to move said gripper apparatus in said “Y” direction, said gripper apparatus configured to access items with respect to said storage shelves and said at least one data storage drive in said “Z” direction, wherein at least one of said gripper apparatus is configured to pivot about an axis of said robot accessor away from substantially said “Z” direction to provide clearance of said gripper apparatus with respect to another said robot accessor on said separate path in said “Z” direction such that said at least two robot accessors may pass each other in said “X” direction on said separate paths.

2. The automated data storage library of claim 1, wherein said gripper apparatus of said at least two robot accessors are configured to pivot about said axis of an associated said robot accessor away from substantially said “Z” direction to provide clearance with respect to another said robot accessor in said “Z” direction.

3. The automated data storage library of claim 1, wherein said at least one gripper apparatus is configured to pivot about said axis between substantially said “Z” direction and substantially said “Y” direction.

4. The automated data storage library of claim 1, wherein said at least one gripper apparatus is configured to pivot about said axis between substantially said “Z” direction and substantially said “X” direction.

5. The automated data storage library of claim 2, comprising at least two said robot accessors configured to move in the same path parallel to said “X” axis, both of said at least two robot accessors having said gripper apparatus, wherein each said gripper apparatus is configured to pivot about an axis of said robot accessor away from substantially said “Z” direction to provide clearance of said gripper apparatus with respect to another said robot accessor on said separate path in said “Z” direction such that said at least two robot accessors may pass said another robot accessor in said “X” direction on said separate paths.

6. An accessor robot configured for use in an automated data storage library, said automated data storage library comprising a plurality of storage shelves arranged in the “X” and “Y” directions on at least one side of an “X” axis, displaced in the “Z” direction from said “X” axis; at least one data storage drive on at least one side of said “X” axis, displaced in said “Z” direction from said “X” axis; and at least one “X” rail extending parallel to said “X” axis; said accessor robot comprising:
“X” drive apparatus configured to move said robot accessor said “X” direction along said at least one “X” rail;
gripper apparatus configured to access items with respect to said storage shelves and said at least one data storage drive in said “Z” direction, and configured to pivot about an axis of said robot accessor away from substantially said “Z” direction to provide clearance in said “Z” direction of said gripper apparatus with respect to another robot accessor configured to move on a separate path parallel to said “X” axis, such that said at least two robot accessors may pass each other in said “X” direction; and
“Y” drive apparatus configured to move said gripper apparatus in said “Y” direction.

7. The accessor robot of claim 6, wherein said gripper apparatus is configured to pivot about said axis between substantially said “Z” direction and substantially said “Y” direction.

8. The accessor robot of claim 6, wherein said gripper apparatus is configured to pivot about said axis between substantially said “Z” direction and substantially said “X” direction.

9. The accessor robot of claim 6, wherein said gripper apparatus is positioned with respect to said robot accessor so as to be centrally located from either side of an aisle extending along said “X” axis and formed by said storage shelves as positioned on either side of said “X” axis, said gripper apparatus configured to access at least said storage shelves on either side of said “X” axis.

10. A method for operating an automated data storage library, said automated data storage library comprising a plurality of storage shelves arranged in the “X” and “Y” directions on at least one side of an “X” axis, displaced in the “Z” direction from said “X” axis, at least one data storage drive on at least one side of said “X” axis, displaced in said “Z” direction from said “X” axis; at least one “X” rail extending parallel to said “X” axis; and a plurality of robot accessors configured to move in said “X” direction along said at least one “X” rail, at least two of said robot accessors configured to move in separate paths parallel to said “X” axis; said robot accessors each having gripper apparatus, said robot accessor configured to move said gripper apparatus in said “Y” direction, said gripper apparatus configured to access items with respect to said storage shelves and said at least one data storage drive in said “Z” direction; comprising the steps of:
pivoting at least one of said gripper apparatus about an axis of said robot accessor away from substantially said “Z” direction to provide clearance of said gripper apparatus with respect to another said robot accessor on a separate path in said “Z” direction; and
moving at least one of said robot accessors in said “X” direction to pass at least said another robot accessor in said separate path.

11. The method of claim 10, wherein said pivoting step comprises pivoting said gripper apparatus of each of at least two said robot accessors on said separate paths about said axis of an associated said robot accessor away from substantially said “Z” direction to provide clearance with respect to each other in said “Z” direction.

12. The method of claim 10, wherein said pivoting step comprises pivoting said at least one gripper apparatus about said axis between substantially said “Z” direction and substantially said “Y” direction.

13. The method of claim 10, wherein said pivoting step comprises pivoting said at least one gripper apparatus about said axis between substantially said “Z” direction and substantially said “X” direction.
